(19) United States
(12) Patent Application Publication
(10) Pub. No.: US 2015/0267966 A1
(43) Pub. Date: Sep. 24, 2015

(54) ADAPTABLE HEAT EXCHANGER AND FABRICATION METHOD THEREOF

(71) Applicant: Metal Industries Research & Development Centre, Kaohsiung (TW)

(72) Inventors: Kuo-Wei Lin, Kaohsiung City (TW); Hung-Lu Yen, Kaohsiung City (TW); Tai-Hsin Hsu, Keelung City (TW); Yuan-Chih Lin, Kaohsiung City (TW); Da-Yu Lin, Taichung City (TW); De-Chang Tsai, Kaohsiung City (TW)

(73) Assignee: Metal Industries Research & Development Centre, Kaohsiung (TW)

(21) Appl. No.: 14/217,496

(22) Filed: Mar. 18, 2014

(51) Int. Cl. F28D 7/00; B23P 15/26

(52) U.S. Cl. CPC F28D 7/0016; B23P 15/26; F28D 7/0058

(57) ABSTRACT

A method of fabricating a heat exchanger unit is provided. The method includes forming a first heat exchange component by providing a first inlet interface device; providing a first outlet interface device; providing a first set of pipes; and connecting respective first ends of each of the first set of pipes to the first inlet interface device and connecting a respective second ends of the each of the first set of pipes to the first outlet interface device. The method further includes forming a second heat exchange component in the same fashion as the first heat exchange component. The method also includes overlapping the first and second heat exchange components and cross-coupling the first set of pipes and the second set of pipes at a plurality of joints.

### TECHNICAL FIELD

The disclosure generally relates to a heat exchanger apparatus, and, more particularly, to a stackable Single-Multiple-Single (or SMS) pipe-frame heat exchanger design and fabrication method thereof.

### BACKGROUND

A heat exchanger is an apparatus designed for heat transfer from a hot medium to a cold medium. Generally, these hot and cold media are separated by a wall to prevent mixing; occasionally, they can be in direct contact.

The heat exchangers are used in a wide array of applications, such as room heating, refrigeration, air conditioning, power plants, chemical plants, petrochemical plants, petroleum refineries, natural gas processing, and sewage treatment. One classic application of a heat exchanger is in an automobile engine. For example, a coolant carries the heat from the automobile engine then it flows through radiator coils. Cold air flows passing the coils and cools the coolant. The coolant then circulates back to the automobile engine again to carry more heat.

There are three primary classifications of heat exchangers according to their flow patterns. These are: (1) parallel-flow heat exchangers, where the two fluids enter the exchanger at the same end and travel in parallel to the other side; (2) counter-flow heat exchangers, where the fluids enter the exchanger from opposite ends; (3) cross-flow heat exchanger, where the fluids travel roughly perpendicular to one another through the exchanger.

In principle, the efficiency of a heat exchanger can be maximized by maximizing the surface area of the wall between the hot and cold fluids, and minimizing resistance to fluid flow through the exchanger.

### SUMMARY

A method of fabricating a heat exchanger unit is disclosed. The method includes forming a first heat exchange component by providing a first inlet interface device; providing a first outlet interface device; providing a first set of pipes; and connecting respective first ends of each of the first set of pipes to the first inlet interface device and connecting a respective second ends of the each of the first set of pipes to the first outlet interface device. The method further includes forming a second heat exchange component in the same fashion as the first heat exchange component. The method also includes overlapping the first and second heat exchange components and cross-coupling the first set of pipes and the second set of pipes at a plurality of joints.

Further disclosed is a heat exchanger unit. The heat exchange unit includes: a first heat exchanger component including: a first inlet interface device; a first outlet interface device; a plurality of first pipes, each of the plurality of first pipes comprising a first end and a second end, and the first end coupling to the first outlet interface device, while the second end coupling to the second outlet interface device. The heat exchanger unit further includes a second heat exchanger component including: a second inlet interface device; a second outlet interface device; and a plurality of second pipes, each of the plurality of second pipes comprising a third end and a fourth end, and the third end coupling to the second inlet interface device and a fourth end coupling to the second outlet interface device, wherein the first and second heat exchange components are overlapped and coupled at a plurality of joints.

Several exemplary embodiments accompanied with figures are described in detail below to further describe the disclosure in details.

### BRIEF DESCRIPTION OF THR DRAWING

The accompanying drawings are included to provide further understanding, and are incorporated in and constitute a part of this specification. The drawings illustrate exemplary embodiments and, together with the description, serve to explain the principles of the disclosure.

FIG. 1A is a perspective diagram of a SMS (Single-Multiple-Single) type pipe-frame heat exchanger component according to an exemplary embodiment of the disclosure.

FIG. 1B is a perspective diagram of a SMS (Single-Multiple-Single) type pipe-frame heat exchanger component according to another exemplary embodiment of the disclosure.

FIG. 2A is a perspective diagram of an inlet device of a heat exchanger component according to an exemplary embodiment of the disclosure.

FIG. 2B is a perspective diagram of an outlet device of a heat exchanger component according to an exemplary embodiment of the disclosure.

FIG. 3A is a perspective diagram of a voided heat exchanger unit according to an exemplary embodiment of the disclosure.

FIG. 3B is a perspective diagram of a voided heat exchanger unit according to another exemplary embodiment of the disclosure.

FIGS. 4A, 4B and 4C are perspective diagrams of pipe coupling schemes of the heat exchanger units in FIGS. 3A and 3B according to an exemplary embodiment of the disclosure.

FIGS. 5A, 5B and 5C are perspective diagrams of pipe coupling schemes of the heat exchanger units in FIGS. 3A and 3B according to another exemplary embodiment of the disclosure.

FIG. 6 is an explosion diagram of a voided heat exchanger unit with intermediated packaging materials.

FIG. 7A is an explosion diagram of a seamless heat exchanger unit according to an exemplary embodiment of the disclosure.

FIG. 7B is a perspective diagram of an assembled seamless heat exchanger unit of FIG. 7A.

FIG. 7C is a perspective diagram of a seamless heat exchanger unit arranged to form a certain flow pattern.

FIG. 8 is a perspective diagram illustrating the method of vertically stacking a plurality of voided heat exchanger units to form an adaptable heat exchanger module according to an exemplary embodiment of the disclosure.

FIG. 9 is a perspective diagram of the assembled adaptable heat exchanger module of FIG. 8.

FIG. 10 is a perspective diagram illustrating a method of vertically stacking the seamless heat exchanger units to form an adaptable heat exchanger module according to exemplary embodiment of the disclosure.

FIG. 11 is a perspective diagram of the assembled adaptable heat exchanger module of FIG. 10.

FIG. 12 is a perspective diagram depicting an adaptable heat exchanger module of the seamless heat exchanger units of FIG. 7 with external pipe connections.

FIG. 13 is a perspective diagram depicting a method of laterally coupling the seamless heat exchanger units side-by-side according to an exemplary embodiment of the disclosure.

FIG. 14 is a perspective diagram depicting the vertically and laterally coupled of the seamless heat exchanger units according to an exemplary embodiment of the disclosure.

FIG. 15A is a perspective diagram of a seamless adaptable heat exchanger module having re-pump units and depicting the ways of micro re-pump devices work according to an exemplary embodiment of the disclosure. FIG. 15B is a schematic diagram of micro re-pump devices.

FIG. 16 is a perspective diagram depicting a method of corrugating the pipes of the heat exchanger components.

FIG. 17 is a perspective diagram illustrating of using a mechanical frame for holding the stacking seamless heat exchanger units according to exemplary embodiment of the disclosure.

### DETAILED DESCRIPTION OF DISCLOSED EMBODIMENTS

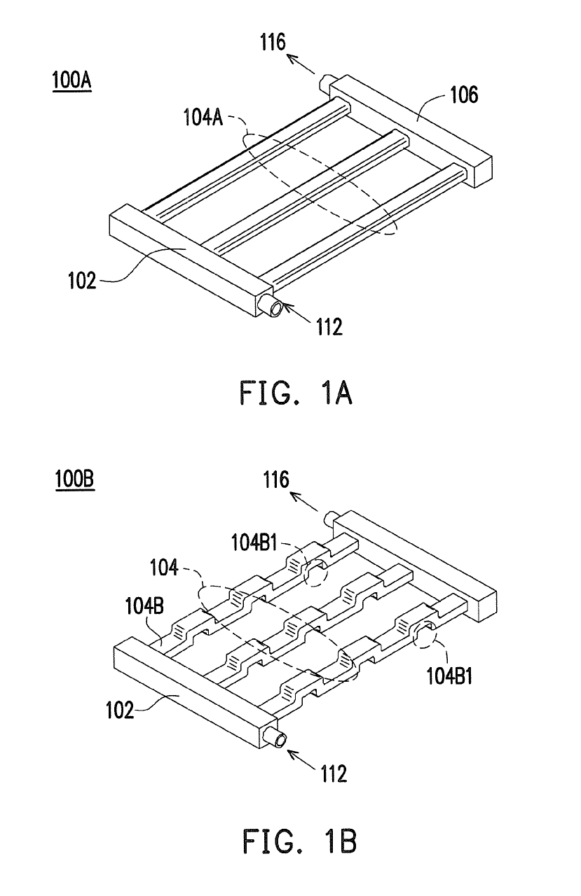

A perspective diagram of a SMS (Single-Multiple-Single) type pipe-frame heat exchanger component according to one embodiment of the present disclosure is shown in FIG. 1A. A method to form such heat exchanger component (100A) may comprise: (1) preparing an inlet interface device (102); (2) preparing an outlet interface device (106); (3) preparing a set of pipes (104); (4) connecting a first end of each pipe to the inlet interface device (102) and a second end of each pipe to the outlet interface device (106) by welding or any other appropriate method. The resulting SMS type pipe-frame heat exchanger component comprises a Single inlet interface device (102), a Single outlet interface device (106) and Multiple of pipes (104A). Once they are assembled, the SMS pipe frame component is thus formed. The SMS pipe frame design allows a medium to enter from the inlet (112), flow along the single inlet interface device (102), and then diverge into the multiple pipes (104A). Ultimately, the medium converges at the single outlet interface device (106) and exits through the outlet (116).

The plurality of pipes (104A) is arranged substantially in parallel to each other. It is understandable these pipes can also be arranged in a different or non-parallel format. Further, the plurality of pipes can be corrugated pipes 104(B) as shown in FIG. 1B. In this example, the joint areas of the pipes are corrugated to form a concave portion (104B1) as shown in FIG. 1B.

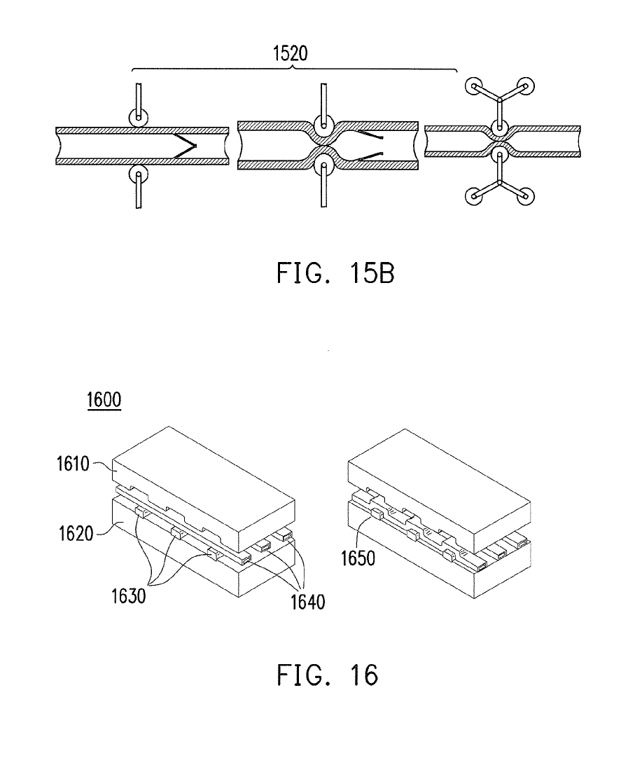

A method to form the corrugated portions is achieved by, for example as shown in FIG. 16, a mechanical pressing process using an upper mold (1610) and a lower mold (1620), wherein the upper mold (1610) has a predesigned depressed portions and the lower mold (1620) has a raised portions (1630) corresponding to the depressed portions of the upper mold (1610). After compressing the upper mold 1610 and the lower mold 1620 together with the raw pipes 1640 positioned there-between, multiple corrugated joint portions (1650) are formed along the pipes.

The shapes of the pipes may be rectangular, square, rhombus, oval, circular, triangular and polygon. It can also be any other reasonable shapes not mentioned above.

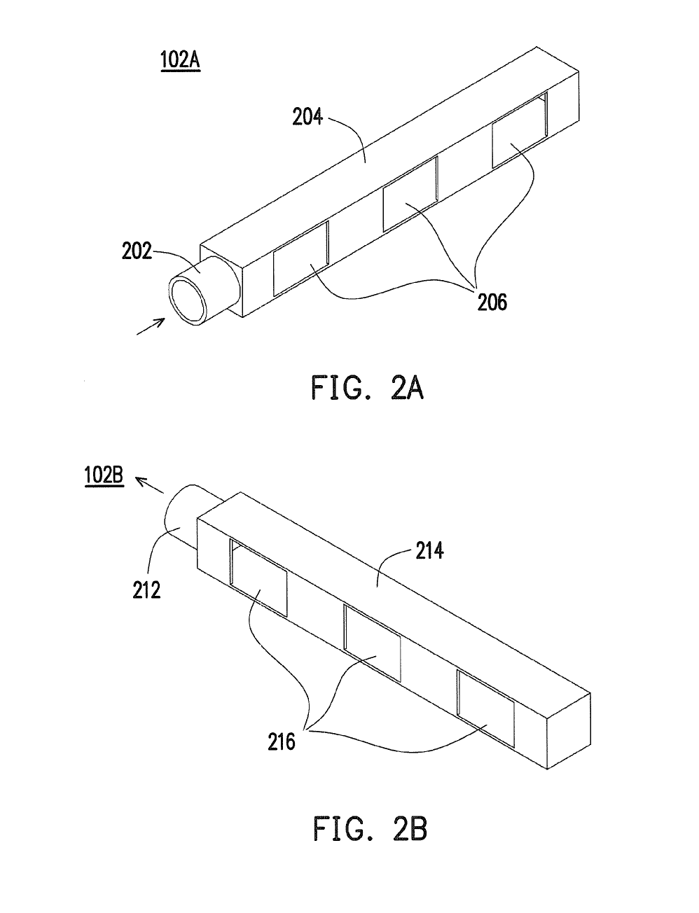

The inlet interface device (102) further comprises an inlet (202), a body (204) and a plurality of output holes (206) located on one side of the body as shown in FIG. 2A. The output holes (206) on the body (204) are prepared for coupling to the first end of each pipe (pipes are not shown in FIG. 2A). Similarly, the outlet interface device (106) comprises an outlet (212), a body (214) and a plurality of input holes (216) on the body (214) as shown in FIG. 2B. The input holes (216) on the body are prepared for coupling to a second end of each pipe (pipes are not shown in FIG. 2B).

In order to reduce the flow resistance, it may be desirable to make the height of the inlet and outlet holes the same height as the pipes. For the same reason, it is also understandable that the inlet and out interface device are not necessarily made with a uniform cross-section. For example, the cross-sectional area of the pipe in the upstream area may be slightly bigger than that of downstream area (not shown).

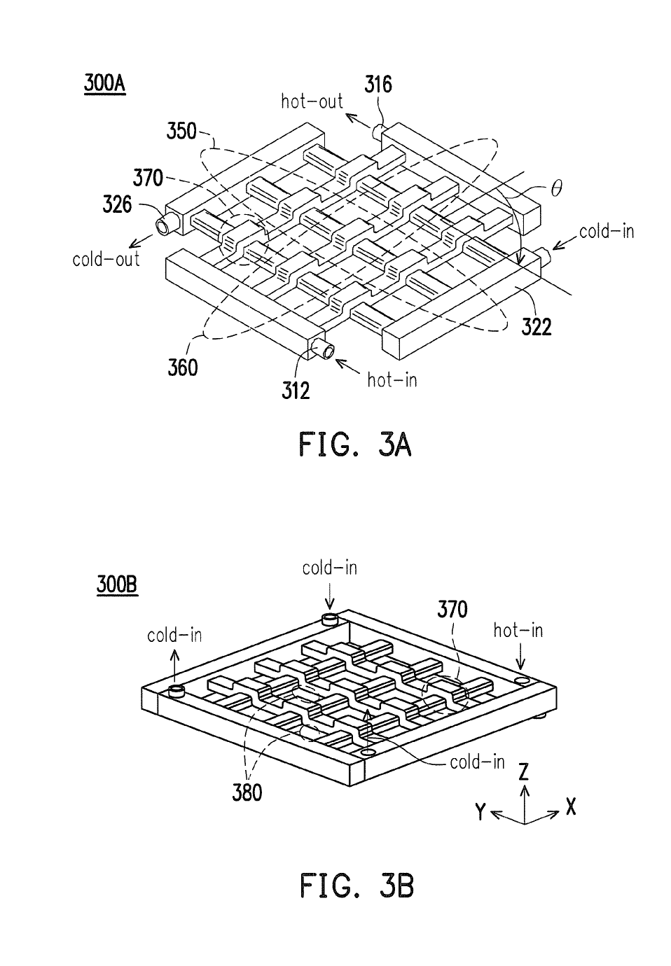

FIG. 3A is a perspective diagram of an exemplary embodiment of a void typed heat exchanger unit (300A) of the disclosure. Generally, the void typed heat exchanger unit (300A) in FIG. 3A is an assembly of the heat exchanger components of FIGS. 1A, 1B, 2A and 2B. As shown in FIG. 3A, a first embodiment of heat exchanger unit includes a first heat exchanger component (350) that comprises a cold-in inlet (322), a plurality of pipes (350s) and a cold out outlet (326), and a second heat exchanger component (360) that comprises a hot-in inlet (312), a plurality of pipes (360s) and a hot-out outlet (316), wherein the first heat exchanger component (350) and the second heat exchanger component (360) are cross coupled to each other to form a plurality of joints (370). More particularly, the first set of pipes of the first heat exchanger component (350) and the second set of pipes of the second heat exchanger component (360) are thermally coupled in terms of forming physical contact at the joint areas (370s). In addition, other methods such as applying thermal conductive adhesive materials, welding, thermal gluing at these joint areas (370) can also be used. These two sets of pipes are crossed over to form an angle θ, which is ranged from 0° to 180°.

The joint areas (370) and/or the surrounding areas of the joints (370) can also be coated with a coating agent to further enhance thermal conductivity. The coating agent, for example, is a thermal-conductive material, which may comprise graphene, magnesium alloy, aluminum, copper, carbon nanotube, carbon nanocapsule, thermal interface materials or a combination thereof.

The coating agent is applied at the joint areas (370) to improve not only thermal conduction of the medium, but may also enhance bonding strength, resistance to corrosion, and vibration.

As shown in FIG. 3B, another exemplary embodiment of a void typed heat exchanger unit (300B) is illustrated. Such design is applicable for stacking since the inlets and the outlets (i.e. hot-in, hot-out, cold-in and cold-out) of each unit are formed in a vertical direction (or the z-direction) as shown in FIG. 3B. Other than ability for stacking, another advantage of this arrangement is its robust physical strength to hold the pipe frame.

A plurality of voids (380) around the joint areas is formed after the first and the second heat exchanger components (350, 360) are coupled to each other as shown in FIG. 3B. Such void areas would form a flow passage for a third dimensional flow medium, which includes, but is not limited to, water, air, fluid, coolant or a combination thereof, to participate in the heat exchanging activities.

The third dimensional flow medium further enhances the efficiency of the void typed heat exchanger. The third dimensional flow medium mentioned above can be driven by power fan, pump or other power sources. The flow direction of the third dimensional flow medium is vertical to the heat exchanger unit (300A). In other words, the flow direction of the third dimensional flow medium is different from the media flow directions in the heat exchange components (350, 360); for example, the flow direction of the third dimensional flow medium is substantially perpendicular (or z direction) to the flow directions of the media in the heat exchanger components (350, 360), which are along the x-y plane, as shown in FIG. 3B.

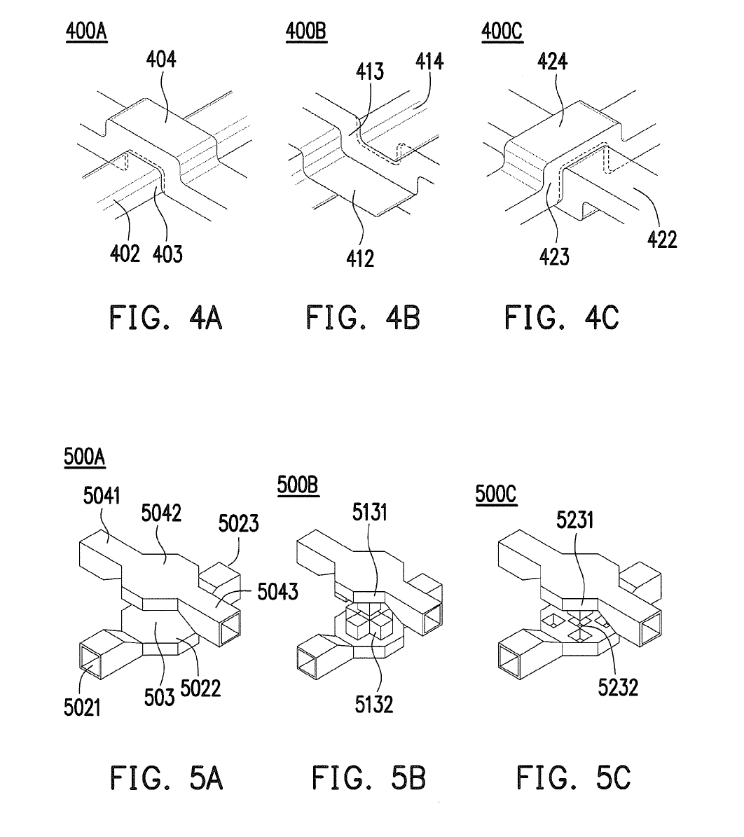

Different configurations of joint are shown in FIGS. 4A to 4C. As shown in FIG. 4A (or 400A), the upper pipe (404) enfolds a portion of the lower pipe (402), and the contact interface between these two pipes is depicted by the dotted line (403). In another exemplary embodiment as shown in FIG. 4B (or 400B), the lower pipe (412) enfolds a portion of the upper pipe (414). The contact interface between these two pipes is depicted by the dotted line 413. As shown in FIG. 4C (or 400C), the lower pipe (422) and the upper pipe (424) are intertwined, wherein the corrugated portions of the upper pipe (424) are fitted with the lower pipe (422). Being intertwined in this exemplary embodiment means the upper pipe and the lower pipe are both corrugated so they can have same degree of coupling but with less flow resistance in both pipes. The contact interface between these two pipes is depicted by the dotted line (423). There are more possible coupling schemes with a similar principle which should not be excluded from this embodiment.

Another set of configurations of joint schemes are shown in FIGS. 5A to 5C. As shown in FIG. 5A (or 500A), the upper pipe comprises an inlet portion (5043), an outlet portion (5041) and an enlarged joint contact area (5042); the lower pipe also comprises an inlet portion (5023), an outlet portion (5021) and an enlarged joint contact area (5022). Two pipes are joined at the enlarged joint area (5042, 503, 5022). As mentioned above, a thermal-conductive paste can be applied to the joint area to enhance thermal coupling. As shown in FIGS. 5B and 5C (500B and 500C), wherein the enlarged joint area is provided with more coupling features to further increase the surface contact area. For example, feature (5131) is a male-type coupling device, while feature (5231) is a female-type coupling device. Joints with different configurations mentioned above can also be achieved, for example, by a pressing process with an appropriate mold. While designing such coupling joints, one must also consider maintaining lowest flow resistance.

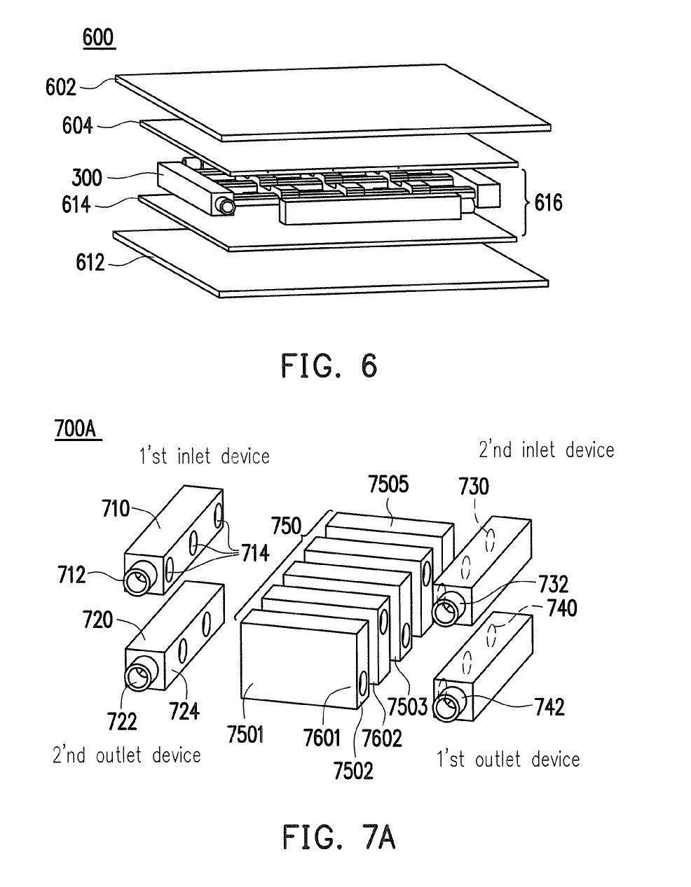

An exploded diagram of the void typed heat exchanger unit of the first embodiment assembled by using intermediated packaging materials (600A) is shown in FIG. 6. The void typed heat exchanger unit (300) is encapsulated by an upper thermal conductive layer (604), which is then capped by an upper protective layer (602), and the heat exchanger unit is also encapsulated by a lower thermal conductive layer (614), which is capped by a lower protective layer (612). A coating agent (not shown) can also be applied at joint areas (616) to further improve thermal coupling quality. The coating agent can also be used to improve coupling quality including thermal conduction, bonding strength, vibration reduction, and anti-corrosion.

The coating agent can be selected, but not limited, from the group consisting of graphene, magnesium alloy, aluminum, copper, carbon nanotube, carbon nanocapsule, thermal interface materials and a combination thereof. There are more possible coupling schemes with a similar principle which should not be excluded from this embodiment.

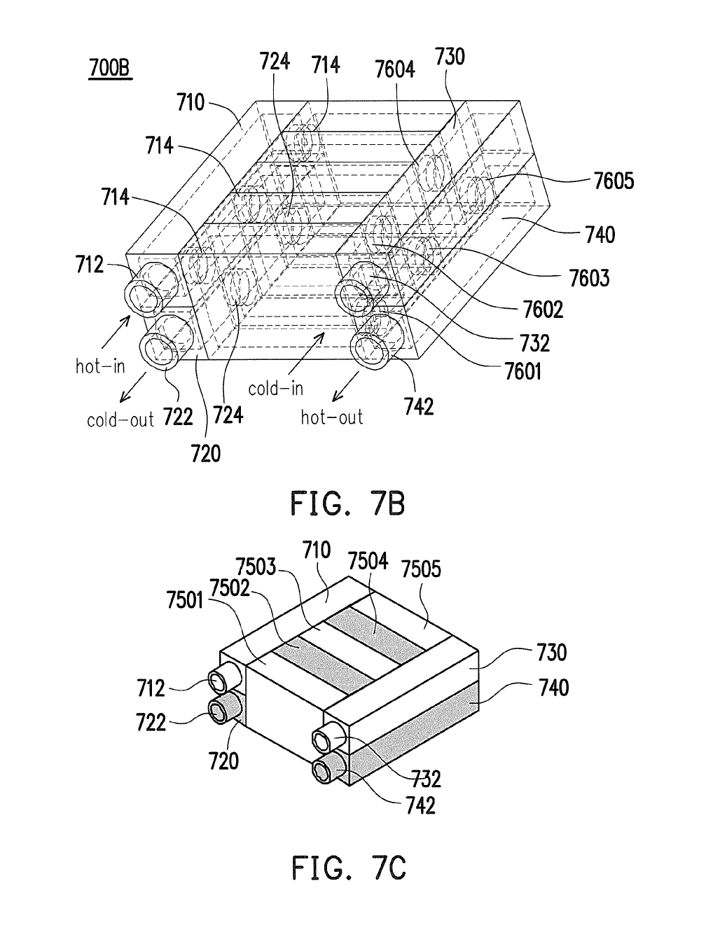

FIGS. 7A to 7C are diagrams of a seamless typed heat exchanger unit (700A, 700B, 700C) according to another embodiment of the present disclosure. An explosion diagram of such seamless typed heat exchanger unit design is shown in FIG. 7A. The seamless typed heat exchanger unit includes a first heat exchanger component essentially comprising: (1) a first inlet device (710) having an inlet (712) formed in the front surface and a plurality of outlet holes (714); (2) a plurality of odd number of pipes (7501,7503 and 7505); and (3) a first outlet device (740) having an outlet (742) also formed in the front surface, and a plurality of inlet holes (7601, 7603,7605 see FIG. 7B). It is understandable that inlet and outlet can also be formed on the opposed surface, for example, with one being formed in the front surface, the other one being formed in the rear surface, and the details thereof are explained herein.

The seamless typed heat exchanger unit further includes a second heat exchanger component whose structure basically is similar to that of the first heat exchanger component, comprising: (1) a second inlet device (730) having an inlet (732) formed in the front surface, and a plurality of outlet holes (7602 and 7604 see FIG. 7B); (2) a plurality of even number pipes (7502 and 7504 see FIG. 7C); and (3) a second outlet device 720 having an outlet 722 also formed in the front surface, and a plurality of inlet holes (724 see FIG. 7B).

When all the parts of the first and second components mentioned above are assembled, the resulting seamless typed heat exchanger as shown in FIG. 7B. Herein, a hot-in media enters an inlet (712) located in left-front-upper location of the unit, flows along the inlet interface device (710), and diverges into the multiple odd number pipes (7501, 7503 and 7505). Eventually, the hot-in medium converges at the outlet interface device (740) and exits through an outlet (742) located in right-front-lower location of the unit. Similarly, a cold-in media enters an inlet (732) located in right-front-upper location of the unit, flows along the inlet interface device (730), and then diverges into the multiple even number pipes (7502 and 7504). Eventually, the cold-in medium converges at the outlet interface device (720) and exits through an outlet (722) located in left-front-lower location of the unit. The flow media can be water, air, fluid, coolant or other material not mentioned here.

It is also possible to arrange the flow pattern differently than that mentioned above. As shown in FIG. 7C, the cold (or hot) media flows in the unit through an inlet (742) located in right-front-lower location of the unit and flows out through an outlet (722) located in left-front-lower location of the unit, while the hot (or cold) media flows in the unit through an inlet (712) located in left-front-upper location of the unit and flows out through an outlet (732) located in right-front-upper location of the unit. It is also possible to arrange the inlet and outlet on either front or rear side of the unit (not shown).

The seamless typed heat exchanger unit (700A, 700B, 700C) of FIG. 7A to 7C is assembled by coupling a first heat exchanger component and a second heat exchanger component together with a de minimis number of voids (or so called seamless) therebetween. Moreover, each of the first heat exchanger component and the second heat exchanger is assembled by a coupling method including welding, gluing, compressing, plugging, fitting, screwing, etc.

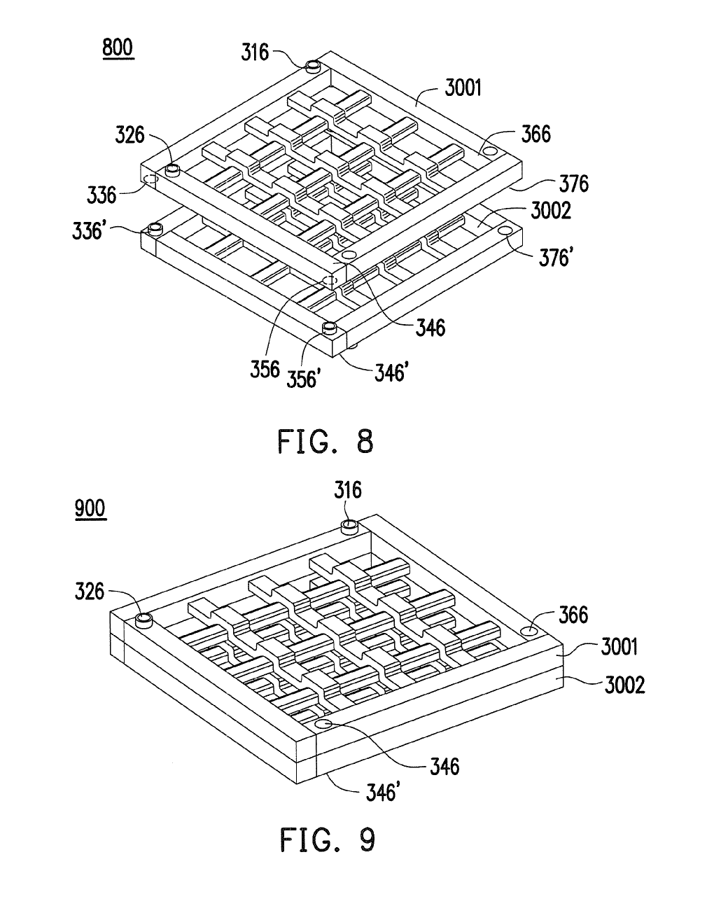

FIG. 8 is a perspective diagram depicting a method of stacking two voided heat exchanger units to form an adaptable heat exchanger module (800) according to an exemplary embodiment of the disclosure. As shown in FIG. 8, the first and the second heat exchanger units (3001, 3002) are stacked and bonded together by placing the first heat exchanger unit (3001) on top of the second heat exchange unit (3002), wherein the first outlet (336) of the first heat exchanger unit (3001) is connected to the first inlet (336′) of the second heat exchanger unit (3002), and the second outlet (376) of the second heat exchanger unit (3002) is connected to the second inlet (376′) of the first heat exchanger unit (3001). Moreover, the method of stacking a plurality of voided heat exchanger units may comprise providing a plurality of connecting pipes and/or fitting elements (not shown) to couple adjacent heat exchanger units.

FIG. 9 is a perspective diagram of the void typed adaptable heat exchanger module (900) assembled by two void typed adaptable heat exchanger units (3001 and 3002) as shown in FIG. 8. As shown in FIG. 9, the first (3001) and the second (3002) heat exchanger units are stacked with one unit on top of the other. Such design is applicable for stacking, since the inlets (346) and the outlets (346′) (i.e. hot-in, hot-out, cold-in and cold-out) of each unit are formed in the vertical direction. When two or more units are stacked and assembled, voids (380) are still presented in the center joint area which allows a fan to blow cold air through these voids to enhance thermal exchanging effects.

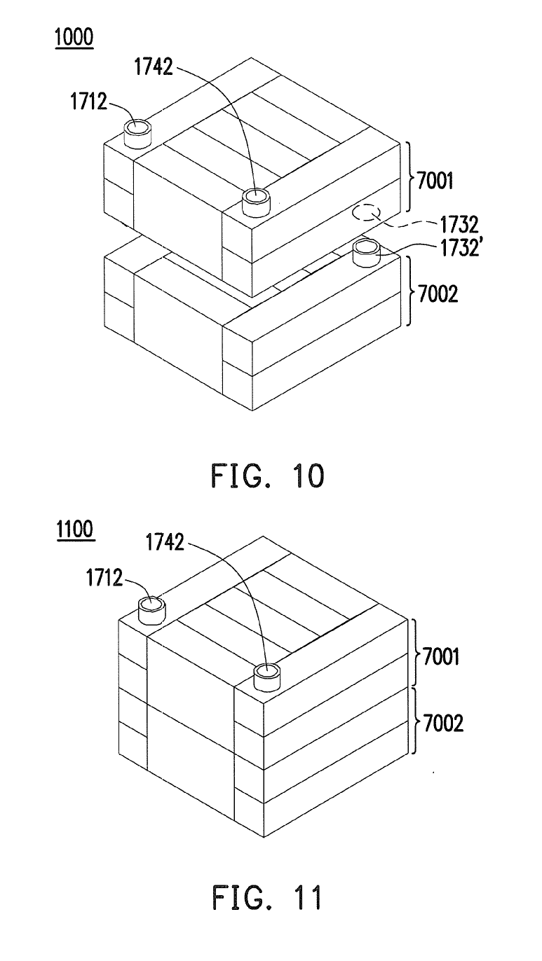

FIG. 10 is a perspective diagram depicting a vertical-stacking of the seamless heat exchanger units according to an exemplary embodiment of the disclosure. The first (7001) and the second (7002) heat exchanger units are stacked and bonded together, wherein the first outlet (1732) of the first heat exchanger unit (7001) is connected to the first inlet (1732′) of the second heat exchanger unit (7002). The first and the second heat exchanger units (7001, 7002) may further comprise a plurality of connecting pipes and/or fittings (not shown) to enhance the mechanical coupling effect.

FIG. 11 is a perspective diagram depicting when two adaptable heat exchanger module of FIG. 10 are stacked vertically. As shown FIG. 11, the first (7001) is mounted on top of the second (7002) heat exchanger units. Such design of the heat exchanger units is applicable for stacking in vertical direction, since the inlets and the outlets (i.e. hot-in, hot-out, cold-in and cold-out) of each unit are formed in the vertical direction.

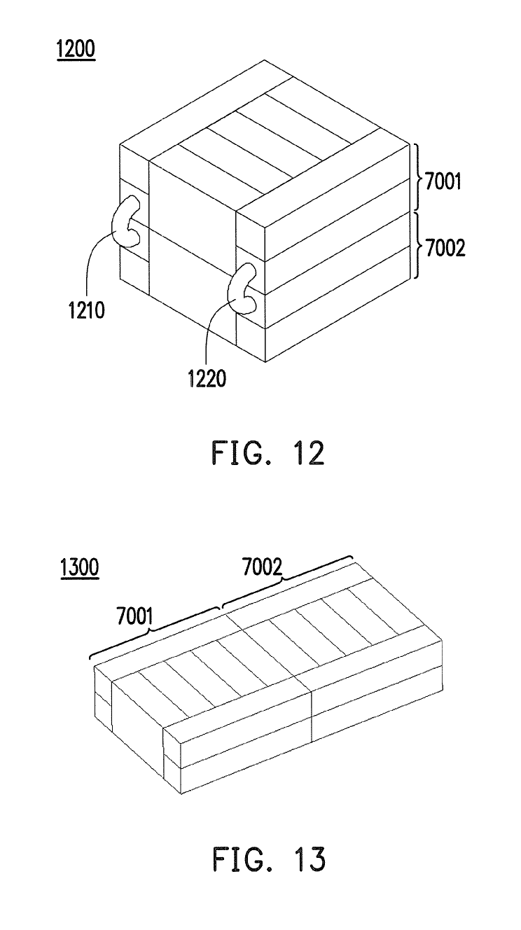

Another embodiment of stacking two seamless heat exchanger units on top of each other is shown in FIG. 12. The first outlet of the upper heat exchanger unit (7001) is connected to the first inlet of the lower heat exchanger unit (7002), and the second outlet of the lower heat exchanger unit (7002) is connected to the second inlet of the upper heat exchanger unit (7001). The outlets and inlets are connected by the external connecting pipes (1210, 1220).

FIG. 13 is a perspective diagram illustrating the method of laterally coupling at least two seamless heat exchanger units to form the seamless heat exchanger system (1300). The inlet and outlet of the second heat exchanger unit 7002 can be connected laterally with the corresponding inlet and outlet of the first heat exchanger unit 7001.

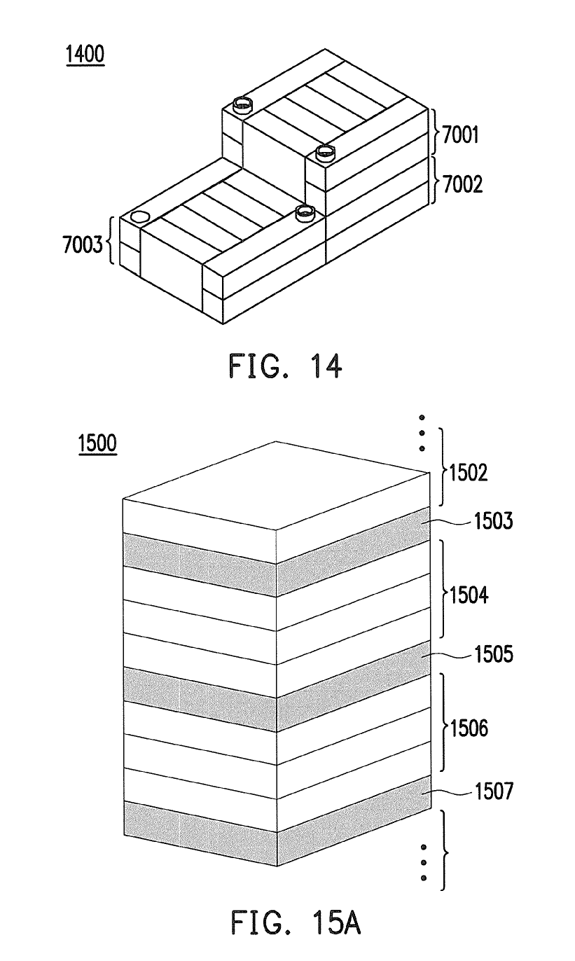

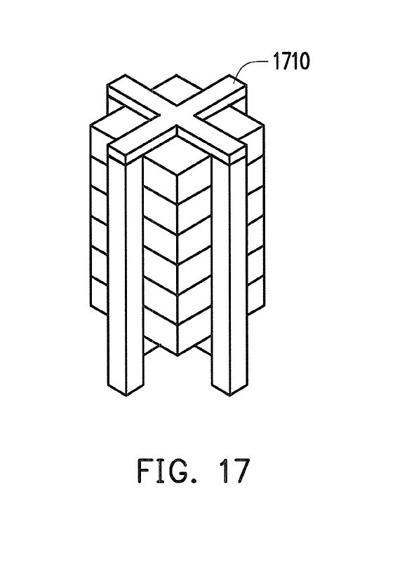

FIG. 14 is a perspective diagram illustrating the method of both vertical and lateral stacking of the seamless heat exchanger units to form the seamless heat exchanger system (1400) according to another exemplary embodiment of the disclosure. As shown in FIG. 14, a plurality of heat exchanger units is coupled both in the lateral and the vertical orientations. A second heat exchanger unit 7002 is connected laterally with a third exchanger unit 7003, while the second heat exchanger unit 7002 can be vertically connected with a first exchanger unit 7001 by having the first exchanger unit 7001 stacked thereon. Both the void and seamless typed heat exchanger units are made in form of modules which can be stackable vertically and/or horizontally. The number of the modules required to be stacked depends on the need and the allowed space. A mechanical frame (1710 as shown in FIG. 17) may be provided for enforcing each unit to enhance the mechanical strength of the structure.

FIGS. 15A and 15B illustrate a seamless adaptable heat exchanger module with at least one re-pump units inserted and micro re-pump devices (1520) may work to retain the flow in long retention pipe system. According to this exemplary embodiment of the disclosure, the heat exchanger module (1500) is formed by further coupling the heat exchanger components (1502, 1504, and 1506) with intermediate re-pump units (1503, 1505, and 1507). In the application of large heat exchanging in a compact volume, the flow resistance may become larger. To overcome, at least one re-pumping unit (1503, 1505, and 1507) is provided for maintaining the heat exchange efficiency. The re-pump unit (1503, 1505, and 1507) may further comprise at least one peristalsis (or wriggle) unit for maintaining the heat exchange efficiency. It is desirable to fabricate such re-pump unit which can be inserted into the existing heat exchanger units by design to minimize the flow resistance. Such compatible design will also save space. The heat exchanger module of the current and the above exemplary embodiments may include at least one flow medium comprising, but not limited to, water, oil, refrigerant, fluid containing particles, or a combination thereof, wherein the particles include magnetic particles.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of fabricating a heat exchanger unit, comprising:
forming a first heat exchange component, including:
providing a first inlet interface device;
providing a first outlet interface device;
providing a first set of pipes;
connecting respective first ends of each of the first set of pipes to the first inlet interface device; and
connecting respective second ends of the each of the first set of pipes to the first outlet interface device;
forming a second heat exchange component, including:
providing a second inlet interface device;
providing a second outlet interface device;
providing a second set of pipes;
connecting respective first ends of each of the second set of pipes to the second inlet interface device; and
connecting respective second ends of the each of the second set of pipes to the second outlet interface device; and
overlapping the first and second heat exchange components and cross-coupling the first set of pipes and the second set of pipes at a plurality of joints.

2. The method of forming a heat exchanger unit of claim 1 further comprising corrugating the first set of pipes to form a plurality of corrugated portions, wherein the plurality of joints is formed by coupling the plurality of corrugated portions of the first set of pipes with the second set of pipes.

3. The method of forming a heat exchanger unit of claim 1 further comprising applying a coating agent at the plurality of joints.

4. A heat exchanger unit, comprising:
a first heat exchanger component including:
a first inlet interface device;
a first outlet interface device;
a plurality of first pipes, each of the plurality of first pipes comprising a first end and a second end, the first end coupling to the first outlet interface device, the second end coupling to the second outlet interface device;
a second heat exchanger component including:
a second inlet interface device;
a second outlet interface device; and
a plurality of second pipes each of the plurality of second pipes comprising a third end and a fourth end, the third end coupling to the second inlet interface device and a fourth end coupling to the second outlet interface device, wherein the first and second heat exchange components are overlapped and coupled at a plurality of joints.

5. The heat exchanger unit of claim 4, wherein the first inlet interface device of the first heat exchanger component further comprises:
a first inlet;
a first body; and
a plurality of first outlets on the first body,
wherein each of the plurality of first outlets is coupled to the first end of the each of the plurality of first pipes.

6. The heat exchanger unit of claim 4, wherein the first outlet interface device of the first heat exchanger component further comprises:
a second outlet;
a second body; and
a plurality of second inlets on the second body,
wherein each of the plurality of second inlets is coupled to the second end of the each of the plurality of first pipes.

7. The heat exchanger unit of claim 4, wherein the second inlet interface device of the second heat exchanger component further comprises:
a third inlet;
a third body; and
a plurality of third outlets on the third body,
wherein each of the plurality of third outputs is coupled to the third end of the each of the plurality of second pipes.

8. The heat exchanger unit of claim 4, wherein the second outlet interface device of the second heat exchanger component further comprises:
a fourth outlet;
a fourth body; and
a plurality of fourth inlets on the fourth body,
wherein each of the plurality of fourth inlets is coupled to the second end of the each of the plurality of second pipes.

9. The heat exchanger unit of claim 4, wherein the plurality of the first pipes of first heat exchanger component are arranged substantially in parallel to each other, while the plurality of second pipes of the second heat exchanger component are arranged substantially in parallel to each other.

10. The heat exchanger unit of claim 4, wherein the plurality of first pipes of the first heat exchanger component and the plurality of second pipes of the second heat exchanger component are physically contacted at the plurality of joints.

11. The heat exchanger unit of claim 10, wherein the plurality of first pipes comprises a plurality of corrugated portions at which the plurality of second pipes is physically contacted with to increase a surface contact area at the plurality of joints.

12. The heat exchanger unit of claim 10, wherein the plurality of second pipes comprises a plurality of corrugated portions at which the plurality of first pipes is physically contacted with to increase a surface contact area at the plurality of joints.

13. The heat exchanger unit of claim 10, wherein the plurality of first pipes and the plurality of second pipes are intertwined at the plurality of joints to increase a surface contact area.

14. The heat exchanger unit of claim 10, wherein at least the plurality of the first pipes or the plurality of the second pipes comprises flattened portions at the plurality of joints to increase a surface contact area at the plurality of joints.

15. The heat exchanger unit of claim 10, wherein at least one pair of matching male and female coupling devices is provided at the plurality of joints to increase a surface contact area.

16. The heat exchanger unit of claim 4, wherein a coating agent is applied at the plurality of joints.

17. The heat exchanger unit of claim 16, wherein the coating agent is selected from the group consisting of graphene, magnesium alloy, aluminum, copper, carbon nanotube, carbon nanocapsule, thermal interface materials or a combination thereof.

18. The heat exchanger unit of claim 4, further comprising a plurality of voids around the plurality of joints.

19. The heat exchanger unit of claim 18 further comprising a third dimensional flow media conveying through the voids, wherein a flow direction of the third dimensional flow media is different from flow directions of media in the first and second heat exchanger components.

20. The heat exchanger unit of claim 18, wherein the plurality of voids is filled with a thermally conductive material.

21. The heat exchanger unit of claim 4, wherein the first and the second heat exchanger components are coupled without voids therebetween around the plurality of joints of the first and the second heat exchanger components.

22. An adaptable heat exchanger module, comprising:
a first heat exchanger unit and a second heat exchanger unit connecting together, each of the first and the second heat exchanger units comprising the heat exchanger unit of claim 4, wherein a first outlet of the first heat exchanger unit is connected to a first inlet of the second heat exchanger unit, and a second outlet of a second heat exchanger unit is connected to a second inlet of the first heat exchanger unit.

23. The adaptable heat exchanger module of claim 22, wherein the first and the second heat exchanger units are coupled side-by-side in a horizontal orientation.

24. The adaptable heat exchanger module of claim 22, wherein the first and the second heat exchanger units are stacked in a vertical orientation.

25. The adaptable heat exchanger module of claim 22, wherein the plurality of the first and the second heat exchanger units are coupled in horizontal and vertical orientations.

26. The adaptable heat exchanger module of claim 22, further comprising a plurality of external connecting pipes to couple the adjacent first and second heat exchanger units.

27. The adaptable heat exchanger module of claim 22 further comprising a plurality of embedded connecting pipes to couple the adjacent first and second heat exchanger units.

28. The adaptable heat exchanger module of claim 22 further comprising at least one flow medium selected from the group consisting of water, oil, refrigerant, fluid containing particles, and a combination thereof.

29. The adaptable heat exchanger module of claim 22, wherein the particles include magnetic particles.

30. The adaptable heat exchanger module of claim 22 further comprising at least one re-pumping unit configured between the first and the second heat exchanger units.

31. The adaptable heat exchanger module of claim 22, further comprising at least one magnetic unit.

32. The adaptable heat exchanger module of claim 22 further comprising at least one peristalsis unit.

33. The adaptable heat exchanger module of claim 22 further comprising a mechanical frame for holding each of the first and the second heat exchanger units.
